(19) United States
(12) Patent Application Publication
(10) Pub. No.: US 2003/0125989 A1
(43) Pub. Date: Jul. 3, 2003

(54) System for finding and displaying decision-supporting information in archives

(76) Inventor: Klaus Abraham-Fuchs, Enlargen (DE)

Correspondence Address: HARNESS, DICKEY & PIERCE, P.L.C., P.O.BOX 8910, RESTON, VA, 20195, US

(21) Appl. No.: 10/323,829

(22) Filed: Dec. 20, 2002

(30) Foreign Application Priority Data
Dec. 21, 2001 (DE) 10163470.6

(51) Int. Cl. G06F 17/60

(52) U.S. Cl. 705/3

(57) ABSTRACT

A system and method are for finding and displaying decision-supporting information in electronic patient records or medical archives. A context-based intelligent algorithm autonomously derives keywords from the inputs by the doctor on a local computer-based workstation and searches patient records and/or archives for these keywords. Information relevant to the keywords or a link to this information is then displayed on the local computer-based workstation.

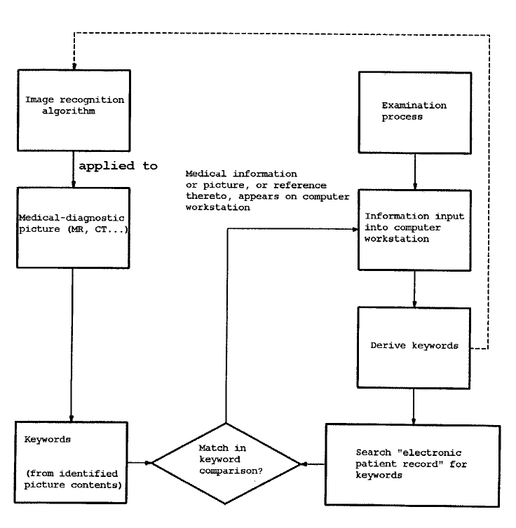

The present application hereby claims priority under 35 U.S.C. §119 on German patent application number 10163470.6 filed Dec. 21, 2001, the entire contents of which are hereby incorporated herein by reference.

### FIELD OF THE INVENTION

The invention generally relates to a system for finding and displaying decision-supporting information in electronic patient records or medical archives.

### BACKGROUND OF THE INVENTION

Health systems today, especially in parts of the world with a high level of industrialization, are characterized by a distinct distribution of roles and a high level of specialization among the doctors. Thus, medically relevant information is collected at many different locations and at a great many different times.

The situation therefore frequently arises in which a doctor currently performing treatment does not have all of the medical information from the patient's medical history available which would be important to the current diagnosis or remedial decision.

This situation will be improved significantly in the future by setting up an “electronic patient record” (EPR) using modem information and communication technologies. One possible implementation of an EPR is to store, by way of example, all medically relevant data at the point of collection (medical practice, hospital, etc.) and to make this information available to other authorized parties at any location and at any time by use of networking to a central server. This is frequently referred to as a decentralized “distributed” EPR.

Although this theoretically indicates that all information which the doctor currently performing treatment would need about a patient's medical history in order to make an optimum remedial decision would be available in future, the volume of information is now becoming much too large for the doctor to be able to search the distributed electronic medical record for relevant information in a feasible amount of time whenever a decision is to be made.

The doctor has therefore largely been reliant on cooperative information from the patient up to now. However, the patient generally does not have the necessary technical competence to know what information from the past would be important to the doctor performing the treatment.

U.S. Pat. No. 6,304,848 B1 describes an apparatus and a method for improving the writing of medical reports, the method involving reports being derived from the data which are input by a doctor, possibly using a keyword database. These keywords serve to give a better structure to the findings and to the medical notes for the patient and to allow access to a knowledge database which contains methods of treatment for corresponding clinical pictures depicted by the headwords. This does not involve improving the data available in the patient data, however, and particularly does not involve the patient data which has been input by the doctor being complemented by the use of earlier data for this very patient as well.

The same applies in a corresponding manner to arrangements for classifying pictures and for creating medical keywords which can be stored with the pictures, in line with JP 10326279 A or WO 01/37131 A2. The mere creation of keywords for picture data does not in itself improve access to electronically stored patient data.

### SUMMARY OF THE INVENTION

An embodiment of the invention may be based on an object of providing a system for finding and displaying decision-supporting information in electronic patient records or medical archives which requires no great involvement from the doctor and no complicated inputs and search advice.

An embodiment of the invention may achieve this object by providing a context-based intelligent algorithm that autonomously derives keywords from the inputs by the doctor on a local computer-based workstation and searches patient records and/or archives for these keywords, and wherein information relevant to the keywords or a link to this information is displayed on the local computer-based workstation.

An aspect of the inventive system is not that keywords are used to search patient records or archives, but rather that such keywords are automatically created when a clinical finding is input on the local computer-based workstation of a doctor, and that the frequently local patient records for the patient are autonomously searched, without the involvement of or any special initiation by the doctor, for entries relating to the keywords automatically created in this manner. If the doctor initially always needs to put a lot of thought into where he has best to search and what prior information he needs to improve the finding for and treatment of a patient who he is currently examining, far too much time passes and in the heat of his work he might even forget one or other specific query. Even initiating such a query is again a separate time-consuming task, which means that, in view of the limited examination time which is available to doctors on account of the large number of patients they have, such enquiries are generally not made at all. The inventive approach of creating the keywords automatically from the entries by the doctor and automatically starting a search in the patient records or in the medical archives, the result of which is displayed on the local computer-based workstation, can deliver extremely helpful results for the problem addressed.

In this case, in one refinement of the invention, a medical thesaurus can be used to derive a plurality of related headwords from a headword derived from the input by the doctor, said related headwords additionally being used for the search. By way of example, when the words “stomach pain” appear in the doctor's input, a further search term “appendix” can be produced by such a thesaurus, which also allows a search using these search words.

In this case, it is often particularly expedient if a headword derived from the input by the doctor is translated into a predefined related search word using such a medical thesaurus so as not to use all possible comparable and related search words for searching, but rather in order to start a standardized search, for example always using the Latin expression. The chance of finding something using this expression is very much higher, since information can certainly be found very much more easily under the Latin technical terms in medical lexicons. A similar situation also applies to entries by other doctors in the electronic patient records, however.

Instead of searching using the search headword itself, such a search headword can also be assigned an administrative code in the health service, such as an “ICD code” or a “DRG code”, in order to perform the search using this standardized code. An ICD code is, by way of example, the code relating to the invoice numbers of the doctors, who, of course, do not input particular illnesses when invoicing the health insurance companies, but rather the associated code descriptor. If the electronic patient records are organized in an appropriate manner, this could also be used to very good effect for searching within the context of the present invention.

If relevant information is found in the patient's electronic patient record (EPR), then a headword characterizing the information appears in a subregion of the graphical user interface on the doctor's computer-based workstation. Preferably, the headword has an associated hidden “link” below it, which means that by clicking on the link it is possible to download all of the information (finding, test values, medical pictures) from the EPR and to display it on the workstation. In another refinement of the invention, not only is the headword shown but also the associated date on which the information found was collected.

In another advantageous refinement of the invention, the information has previously been classified into “confidential” information and “nonconfidential” information. If the context-sensitive browser finds information identified as being “confidential”, then the screen in front of the doctor performing the treatment shows only advice which is in itself still not confidential, possibly just the date of the event and the keyword. The doctor now knows that an event which is possibly relevant to a decision has occurred in the past, and he can use the advice shown on the screen to ask the patient about this. The patient then needs to make his own mind up whether he wishes to talk about it.

As already indicated further above, an embodiment of the invention can also provide that the information found is not itself displayed in full on the screen, but rather only partial information which characterizes this information and comprises a subset of the total information available. This partial information may be, by way of example: the headword found, the time of the entry, the organization supplying the information, the name of the person who entered the information, associated administrative codes such as ICD or DRG, or the like.

To eliminate the risk of access by unauthorized persons for a search in accordance with an embodiment of the invention, a further refinement of the invention can provide for the information found to be released and displayed only after an access protection mechanism, such as password input, has been applied.

With particularly extensive electronic patient records or when archives are also being searched at the same time, a further refinement of the invention can provide for the information found using the headword search to be assessed by intelligent computer-based expert systems to determine whether it is relevant to a decision for the current examination process, and for only information which is relevant to a decision to be displayed on the screen. An example of this is if the headwords “stomach pain” find information available from an accident a long way in the past, involving lacerations to the stomach, in the EPR. The expert system would not use this information, since this old healed stomach injury certainly ought not be one of the possible causes currently being sought for stomach pain.

In many cases, the electronic patient record or a medical archive contains medically diagnostic pictures which are not stored on the basis of particular keywords, which means that it is not at all possible to detect them in such a search. To get around this difficulty, one refinement of the invention provides for a search query containing particular keywords to cause stored medically diagnostic pictures in the electronic patient record and/or in the medical archive to be analyzed using image recognition algorithms, and to cause keywords to be generated therefrom for classification, the keywords being compared with the keywords in the search query. In this way, the doctor making the query is provided only with such pictures, or is shown advice of such pictures, as are actually related to the patient's respective illness.

Examples of such image recognition algorithms are 2D or 3D segmentation algorithms which identify body organs from their outlines or from other geometric features and can deliver organ-specific keywords, such as “cardiac image”, “cerebral image”, or the like.

The inventive classification can be made using computer aided diagnosis (CAD) algorithms which provide automatic findings support, such as for identifying tumors, bone fractures, or the like. Texture analysis algorithms can also be used in this context.

### BRIEF DESCRIPTION OF THE DRAWINGS

Further advantages, features and details of the invention can be found in the description below of an exemplary embodiment and with reference to the drawing, which shows a flowchart for different variants of the inventive system.

### DETAILED DESCRIPTION OF THE PREFERRED EMBODIMENTS

The right-hand side of the FIGURE shows how the doctor inputs information on his computer-based workstation in the course of an examination process. From the details which are input, a context-based intelligent algorithm autonomously, that is to say without the involvement of the doctor, derives keywords and likewise automatically starts a search for this keyword or for these keywords in either the electronic patient record EPR or in a medical archive. If matching information is found in the keyword comparison, the medical information or a reference to this information or a picture or a reference thereto appears on the computer workstation.

If it is also necessary to detect medical-diagnostic pictures stored in the EPR which—as is often the case—are not stored with particular keywords, which means that it is not at all possible to detect them in the search currently being described, then one refinement of the invention allows the derivation of keywords on the computer-based workstation (as shown on the left in the figure) to be followed by application of an image recognition algorithm to medical-diagnostic pictures in the electronic patient record or else in a medical archive, with this image recognition algorithm in turn deriving keywords from the analyzed pictures. If this keyword obtained by the image recognition algorithm corresponds to the keyword in the search query which has been started autonomously by the computer-based workstation, then the picture or a reference thereto again appears on the computer workstation.

A specific example of this is as follows:

The doctor enters information about a patient's pregnancy which has just been established into her EPR. The context-based intelligent browser in the background fetches keywords known to it, such as “pregnancy” (or else the associated ICD code, for example) and searches the patient record for earlier pregnancies or else related events, such as termination of a pregnancy. Information found is displayed in a subwindow, possibly together with the associated date. The doctor then decides whether he considers this information to be important to the current treatment process, and can retrieve the full information by tagging, clicking, etc. In this case, an intelligent algorithm can filter the information found further in order to refer just to information which is significant to a decision. Thus, in the example above, no pregnancies which progressed normally are displayed, but rather only those in which complications arose.

In another specific example, the doctor enters the name of a prescribed medicament into the electronic patient record. The browser fetches the medicament name, or from an associated database the generic substance in the medicament, searches the EPR and reports intolerances, cross-sensitivities etc. known from the past.

Finally, as a third example, in connection with the pregnancy taken as an example above, a keyword can also be generated under the headword “pregnancy”, “womb” or the like and at the same time an image recognition algorithm can be applied to the unclassified medical-diagnostic pictures in the EPR in order to establish autonomously whether, by way of example, there is a picture of the patient's womb available which, in conjunction with information regarding earlier pregnancies or terminations of pregnancy, could provide the doctor currently performing treatment with information which is highly significant to a decision.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A system for finding and displaying decision-supporting information in at least one of electronic patient records and medical archives, comprising:
a computer-based workstation, including a context-based intelligent algorithm which is adapted to autonomously derive keywords from inputs by a doctor and which is adapted to search at least one of patient records and archives for the derived keywords, wherein at least one of information relevant to the keywords and a link to this information is displayed on the local computer-based workstation.

2. The system as claimed in claim 1, wherein a medical thesaurus is used to derive a plurality of related headwords from a headword derived from the input by the doctor, and wherein these related headwords are additionally used for the search.

3. The system as claimed in claim 1, wherein a headword derived from the input by the doctor is translated into a predefined related search word using a medical thesaurus in order to allow a standardized search.

4. The system as claimed in claim 2, wherein the search headword is assigned to an administrative code in the health service and the search is performed using this standardized code.

5. The system as claimed in claim 1, wherein a context-sensitive browser displays information having the prior classification “confidential” only as advice containing the keyword and date of the event on the computer-based workstation.

6. The system as claimed in claim 5, wherein the information found is not itself displayed in full on the screen, but rather only partial information which characterizes this information and comprises a subset of the information is displayed.

7. The system as claimed in claim 5, wherein the information found is released and displayed only after an access protection mechanism has been applied.

8. The system as claimed in claim 1, wherein the information found using the headword search is assessed by intelligent computer-based expert systems to determine whether it is relevant to a decision for the current examination process, and only information

9. The system as claimed in claim 1, wherein a search query containing particular keywords causes stored medically diagnostic pictures in at least one of the electronic patient record and the medical archive to be analyzed using image recognition algorithms, and causes keywords to be generated therefrom for classification, the keywords being compared with the keywords in the search query.

10. The system as claimed in claim 9, wherein at least one of 2D and 3D segmentation algorithms identify body organs and deliver organ-specific keywords.

11. The system as claimed in claim 9, wherein computer aided diagnosis (CAD) algorithms are used to provide automatic findings support.

12. The system as claimed in claim 3, wherein a headword derived from the input by the doctor is translated into a predefined related search word using a medical thesaurus in order to allow a standardized search.

13. The system as claimed in claim 4, wherein the search headword is assigned to an administrative code in the health service including at least one of an ICD code and a DRG code.

14. The system as claimed in claim 12, wherein the search headword is assigned to an administrative code in the health service including at least one of an ICD code and a DRG code.

15. The system as claimed in claim 2, wherein a context-sensitive browser displays information having the prior classification “confidential” only as advice containing the keyword and date of the event on the computer-based workstation.

16. The system as claimed in claim 15, wherein the information found is not itself displayed in full on the screen, but rather only partial information which characterizes this information and comprises a subset of the information.

17. The system as claimed in claim 6, wherein the information found is released and displayed only after an access protection mechanism has been applied.

18. The system as claimed in claim 2, wherein the information found using the headword search is assessed by intelligent computer-based expert systems to determine whether it is relevant to a decision for the current examination process, and only information which is relevant to a decision is displayed on the screen.

19. The system as claimed in claim 2, wherein a search query containing particular keywords causes stored medically diagnostic pictures in at least one of the electronic patient record and the medical archive to be analyzed using image recognition algorithms, and causes keywords to be generated therefrom for classification, the keywords being compared with the keywords in the search query.

20. The system as claimed in claim 10, wherein computer aided diagnosis (CAD) algorithms are used to provide automatic findings support.

21. A method for finding and displaying decision-supporting information in at least one of electronic patient records and medical archives, comprising:
autonomously deriving keywords from inputs by a doctor using, on a computer-based workstation, a context-based intelligent algorithm;
searching at least one of patient records and archives for the derived keywords; and
displaying at least one of information relevant to the keywords and a link to this information on the local computer-based workstation.

22. The method as claimed in claim 21, wherein a medical thesaurus is used to derive a plurality of related headwords from a headword derived from the input by the doctor, and wherein these related headwords are additionally used for the search.

23. The method as claimed in claim 22, wherein a headword derived from the input by the doctor is translated into a predefined related search word using a medical thesaurus in order to allow a standardized search.

24. The method as claimed in claim 23, wherein the search headword is assigned to an administrative code in the health service and the search is performed using this standardized code.

25. The method as claimed in claim 21, wherein information is displayed on a context-sensitive browser of the computer-based workstation, having the prior classification “confidential” only as advice containing the keyword and date of the event.

26. The method as claimed in claim 25, wherein the information found is not itself displayed in full on the screen, but rather only partial information which characterizes this information and comprises a subset of the information is displayed.

27. The method as claimed in claim 25, wherein the information found is released and displayed only after an access protection mechanism has been applied.

28. The method as claimed in claim 22, wherein the information found using the headword search is assessed by intelligent computer-based expert systems to determine whether it is relevant to a decision for the current examination process, and only information which is relevant to a decision is displayed on the screen.

29. The method as claimed in claim 21, wherein a search query containing particular keywords causes stored medically diagnostic pictures in at least one of the electronic patient record and the medical archive to be analyzed using image recognition algorithms, and causes keywords to be generated therefrom for classification, the keywords being compared with the keywords in the search query.

30. The method as claimed in claim 29, wherein at least one of 2D and 3D segmentation algorithms identify body organs and deliver organ-specific keywords.

31. The method as claimed in claim 29, wherein computer aided diagnosis (CAD) algorithms are used to provide automatic findings support.

32. A system for finding and displaying decision-supporting information in at least one of electronic patient records and medical archives, comprising:
means for autonomously deriving keywords from inputs by a doctor using a context-based intelligent algorithm;
means for searching at least one of patient records and archives for the derived keywords; and
means for displaying at least one of information relevant to the keywords and a link to this information.

33. The system as claimed in claim 32, wherein a medical thesaurus is used to derive a plurality of related headwords from a headword derived from the input by the doctor, and wherein these related headwords are additionally used for the search.

34. The system as claimed in claim 33, wherein a headword derived from the input by the doctor is translated into a predefined related search word using a medical thesaurus in order to allow a standardized search.

35. The system as claimed in claim 34, wherein the search headword is assigned to an administrative code in the health service and the search is performed using this standardized code.
